(19) United States
(12) Patent Application Publication
(10) Pub. No.: US 2012/0288695 A1
(43) Pub. Date: Nov. 15, 2012

(54) Multi-Layer Breathable Films

(76) Inventor: Shawn E. Jenkins, Duluth (GE)

(21) Appl. No.: 13/103,526

(22) Filed: May 9, 2011

(51) Int. Cl. B32B 7/02; B29C 47/06; B32B 27/12; B32B 27/08; B32B 3/00; B32B 9/04

(52) U.S. Cl. 428/216; 428/220; 428/411.1; 442/394; 428/516; 427/245

(57) ABSTRACT

The present invention is directed to a breathable multi-microlayer film material that includes a plurality of alternating coextruded first and second microlayers, wherein the first microlayers comprise an unfilled first polymer composition, and further wherein the second microlayers comprise a second polymer composition and filler particles. The multi-microlayer films may be used in disposable absorbent products, have increased breathability, and generally retain their integrity and strength during processing and use.

### BACKGROUND OF THE INVENTION

Breathable films find widespread use in many applications. For example, breathable films may be used as a liquid-impermeable backsheet in a disposable personal care absorbent product such as, for examples, diapers and training pants sanitary napkins, adult incontinence products, and health care products such as surgical drapes, gowns, or wound dressings. A typical disposable absorbent product generally comprises a composite structure including a liquid-permeable topsheet, a fluid acquisition layer, an absorbent structure, and a liquid-impermeable backsheet. These products usually include some type of fastening system for fitting the product onto the wearer.

Disposable absorbent products are typically subjected to one or more liquid insults, such as of water, urine, menses, or blood, during use. As such, the backsheet materials of the disposable absorbent products are typically made of liquid-insoluble and liquid impermeable materials, such as polyolefin films, that exhibit a sufficient strength and handling capability so that the disposable absorbent product retains its integrity during use by a wearer and does not allow leakage of the liquid insulting the product.

Breathability is an important aspect for personal care articles. For example, breathability in a diaper provides significant skin health benefits to the baby wearing the diaper. Moisture vapors are allowed to pass through the outer cover, leaving the baby's skin drier and less prone to diaper rash.

Breathability of polyolefin films may be achieved by dispersing filler particles, such as, for example, calcium carbonate, in the film and stretching the film to create micropores around the filler particles. Breathability of the films may be increased by addition of additional filler particles, however, increased levels of filler particles results in reduction in production efficiency and decreases in film strength and toughness.

As such, there is a need for new materials that may be used in disposable absorbent products, that have increased breathability, and that generally retain their integrity and strength during processing and use, but have demonstrated improved production efficiency and/or strength attributes.

Alternatively, there is a need for new materials that may be used in disposable absorbent products that require less basis weight to provide target levels of breathability and strength.

### SUMMARY OF THE INVENTION

The present invention is directed to a breathable multi-microlayer film material that includes a plurality of alternating coextruded first and second microlayers, wherein the first microlayers comprise an unfilled first polymer composition, and further wherein the second microlayers comprise a second polymer composition and filler particles.

In one aspect, the unfilled first polymer composition has an inherent WVTR by itself less than about 1000 gm/m²/day, optionally less than about 300 gm/m²/day. In some embodiments, the multi-microlayer film is breathable, optionally wherein the multi-microlayer film has a WVTR greater than about 1000 gm/m²/day, optionally wherein the multi-microlayer film has a WVTR greater than about 21,000 gm/m²/day, and optionally wherein the multi-microlayer film has a WVTR between about 1000 and about 40,000 gm/m²/day.

In another aspect, the filler particles may be selected from the group consisting of metal oxides, metal hydroxides, metal carbonates, carbon black, graphite, graphene, and other predominantly carbonaceous solids, metal sulfates, calcium carbonate, clay, alumina, titanium dioxide, rubber powder, rubber emulsions, pulp powder, wood powder, chitosan powder, acrylic acid powder, or mixtures thereof.

In a further aspect, the multi-microlayer film has a thickness less than about 254 microns. In some embodiments, each microlayer has a thickness of from about 0.001 microns to about 50 microns. In other embodiments, the multi-microlayer film comprises from about 8 to about 4000 microlayers, optionally from about 16 to about 2048 microlayers.

In an even further aspect, the multi-microlayer film may include outer skin layers surrounding the microlayers.

In one aspect, the multi-microlayer film may be stretched from about 100 to about 1000 percent of the film's original as-formed length.

In another aspect, the second micro-layers may include between about 25 wt % and about 95 wt % filler particles by weight of the second micro-layers, optionally wherein the second micro-layers optionally include between about 60 wt % and about 75 wt % filler particles by weight of the second micro-layers. In some embodiments, the multi-microlayer film may include between about 10 wt % and about 90 wt % filler particles by weight of the multi-microlayer film, optionally including between about 30 wt % and about 70 wt % filler particles by weight of the multi-microlayer film.

In a further aspect, a second microlayer comprises neither outermost layer of the multi-microlayer film, optionally a second microlayer comprises one outermost layer of the multi-microlayer film, and optionally a second microlayer comprises both outermost layers of the multi-microlayer film.

In an even further aspect, the multi-microlayer film has a WVTR greater than 1.25× that of an otherwise equivalent non-layered film having the same weight percentage of filler particles and polymer composition. In some embodiments, the multi-microlayer film has substantially equivalent WVTR to that of an otherwise equivalent non-layered film having greater overall weight percentage of filler particles. In other embodiments, the multi-microlayer film has an MD peak tensile force greater than that of an otherwise equivalent non-layered film having greater overall weight percentage of filler particles.

In one aspect, a nonwoven composite includes a nonwoven material and the multi-microlayer film described above laminated to the nonwoven material. In some embodiments, an absorbent article includes an outer cover, a bodyside liner joined to the outer cover, and an absorbent core positioned between the outer cover and the bodyside liner, wherein the absorbent article includes the nonwoven composite described above.

In other aspects, the first unfilled polymer composition comprises a polymer selected from the group consisting of polyolefins and polyolefin copolymers. In some embodiments, the second polymer composition comprises a polymer selected from the group consisting of polyolefins and polyolefin copolymers.

In another embodiment, a method of making a multi-microlayer breathable film includes the steps of:
providing first and second unfilled polymer compositions;
blending filler particles with the second unfilled polymer composition to form a filled polymer composition;
coextruding the first unfilled polymer composition and the filled polymer composition;
splitting the first unfilled polymer composition and the filled polymer composition into multiple alternating layers; and,
forming the multiple alternating layers into a multi-microlayer film having alternating coextruded microlayers.

In one aspect, the filler particles of the method are selected from the group consisting of metal oxides, metal hydroxides, metal carbonates, carbon black, graphite, graphene, and other predominantly carbonaceous solids, metal sulfates, calcium carbonate, clay, alumina, titanium dioxide, rubber powder, rubber emulsions, pulp powder, wood powder, chitosan powder, acrylic acid powder, or mixtures thereof.

In another aspect, each microlayer of the method has a thickness of from about 0.001 microns to about 50 microns. In some embodiments, the multi-microlayer film has a thickness less than about 254 microns. In other embodiments, the multi-microlayer film comprises from about 8 to about 4,000 microlayers, optionally from about 16 to about 2048 microlayers.

In one aspect, the multi-microlayer film of the method is breathable, optionally wherein the multi-microlayer film has a WVTR greater than about 1000 gm/m2/day, optionally wherein the multi-microlayer film has a WVTR greater than about 21,000 gm/m2/day, and optionally wherein the multi-microlayer film has a WVTR between about 1000 and about 40,000 gm/m2/day. In some embodiments, the multi-microlayer film has a WVTR greater than 1.25× that of an otherwise equivalent non-layered film having the same weight percentage of filler particles and polymer composition.

In a further aspect, the method further includes the step of stretching the multi-microlayer film from about 100 to about 800 percent of the film's original as-formed length.

In an even further aspect, the first unfilled polymer composition of the method includes a polymer selected from the group consisting of polyolefins and polyolefin copolymers. In some embodiments, the second unfilled polymer composition includes a polymer selected from the group consisting of polyolefins and polyolefin copolymers.

### BRIEF DESCRIPTION OF THE DRAWINGS

FIG. 1 is a plan view of a coextrusion system for making a microlayer polymer film in accordance with an embodiment of this invention.

FIG. 2 is a schematic diagram illustrating a multiplying die element and the multiplying process used in the coextrusion system illustrated in FIG. 1.

### DETAILED DESCRIPTION OF THE INVENTION

The present invention encompasses a breathable multi-microlayer polymer film that has sufficient strength and breathability for use in applications such as absorbent personal care products. Below is a detailed description of embodiments of this invention including a method for coextruding the microlayer polymer film, followed by a description of uses and properties of the film and particular examples of the film.

The present invention is directed to breathable multi-microlayer polymer films which are made by coextrusion of alternating layers of a first thermoplastic, melt extrudable polymer and a blend of a second thermoplastic, melt extrudable polymer with filler particles. Suitable thermoplastic polymers for use in this invention are stretchable in a solid state and, if required, at elevated temperature to allow a drawing and thinning of the layers and of the overall film during film stretching. In some embodiments, however, the blend of the second thermoplastic, melt extrudable polymer with the filler particles may not be readily formed into a film by itself. In other embodiments, the blend of the second thermoplastic, melt extrudable polymer with the filler particles, even if formable into a film by itself, is not readily stretchable without breaking. Layering of the blend with layers of polymer that don't contain filler permits formation of a stretchable film. Stretching of the multi-microlayer film at elevated temperature may be applied to enhance breathability.

This invention includes multi-microlayer films composed of a multi-microlayer assembly of first thermoplastic, melt extrudable polymer microlayers and microlayers of a blend of a second thermoplastic, melt extrudable polymer with filler particles. By definition, “multi-microlayer” means a film having a plurality of alternating layers wherein, based upon the process by which the film is made, each microlayer becomes partially integrated or adhered with the layers above and below the microlayer. In one aspect, the filler particles may have a characteristic length that is on the order of the thickness of an individual microlayer. The addition of such filler particles may disrupt the local uniformity and orientation of adjacent microlayers, while still resulting in substantially oriented layers. This is in contrast to “multi-layer” films wherein conventional co-extruded film-making equipment forms a film having only a few layers and wherein each layer is generally more separate, distinct, and well oriented relative to each other layer than in multi-microlayer films.

The multi-microlayer polymer film of this invention comprises a plurality of coextruded microlayers which form a laminate structure. The coextruded microlayers include a plurality of first layers comprising a first thermoplastic, melt extrudable polymer and a plurality of second layers comprising a blend of a second thermoplastic, melt extrudable polymer with filler particles. The plurality of first layers and plurality of the second polymer layers are arranged in a series of parallel and/or substantially oriented, repeating laminate units. Each laminate unit comprises at least one of the first polymer layers and at least one of the second layers. In some embodiments, each laminate unit has one or more second polymer layer laminated to a first layer so that the coextruded microlayers alternate between first layers and second layers, i.e., an A/B arrangement. Alternatively, the laminate unit may have three or more layers, for example, an A/B/A arrangement.

In the case of the A/B laminate unit, the resulting multi-microlayered film is arranged as A/B/A/B . . . A/B, where one side is always A and the other side is always B.

In the case of the A/B/A arrangement, the resulting multi-microlayered film is arranged as A/B/A/A/B/A/AB/A . . . A/B/A. In this case, both sides of the multi-microlayered film are always A. In addition, there are adjacent A/A layers imbedded in the multi-microlayered film. Herein, when counting microlayers, adjacent layers of the same composition are counted as one layer. For instance, an A/A arrangement is counted as only one layer.

Desirably, at least one of the outside layers of the laminate unit is one of the second (filled) layers. Then, after stretching and releasing of the film, apertures form in the second layer, the first layer, or both. These apertures produce channels having void spaces through the layers resulting in breathability of the multi-microlayer film.

During stretching the multilayer film also changes dimensions in the direction perpendicular to the stretching direction and in the z-direction (thickness direction). Typically it shrinks in the direction perpendicular to the stretch direction and shrinks in the z-direction.

Each microlayer in the unstretched polymer film has a thickness from about 0.001 micron to about 150 microns. In another embodiment, each unstretched microlayer has a thickness that does not exceed about 10 microns. In another embodiment each unstretched microlayer has a thickness that does not exceed about 1 micron. Each microlayer in the stretched polymer film has a thickness from about 0.0001 micron to about 25 microns. In another embodiment, each stretched microlayer has a thickness that does not exceed about 5 microns. In another embodiment each stretched microlayer has a thickness that does not exceed about 0.5 micron.

Microlayers form laminate films with high integrity and strength because they do not substantially delaminate after microlayer coextrusion due to the partial integration or strong adhesion of the microlayers. Microlayers enable combinations of two or more layers of into a monolithic film with a strong coupling between individual layers. The term “monolithic film” as used herein means a film that has multiple layers which adhere to one another and function as a single unit.

The number of microlayers in the film varies broadly from about 8 to about 4000 in number, and in another embodiment from about 16 to about 2048 in number. However, the thickness of each microlayer in the film is determined by the number of microlayers and the overall film thickness. In one embodiment, the multi-microlayer films, prior to stretching, have a thickness of from about 5 to about 254 microns. In another embodiment, the films, prior to stretching, have a thickness of from about 10 to about 150 microns. In yet another embodiment, the films, prior to stretching, have a thickness of from about 40 to about 90 microns. Basis weight of the films, prior to stretching, may range in some embodiments from about 10 gsm (grams per square meter) to about 200 gsm, in other embodiments from about 30 gsm to about 150 gsm.

The term “melt-extrudable polymer” as used herein means a thermoplastic material having a melt flow rate (MFR) value of not less than about 0.1 grams/10 minutes, based on ASTM D1238. More particularly, the MFR value of suitable melt-extrudable polymers for the unfilled layers of the film may range from about 0.2 g/10 minutes to about 100 g/10 minutes. In another embodiment, the MFR value of suitable melt-extrudable polymers ranges from about 0.4 g/10 minutes to about 50 g/10 minutes. In yet another embodiment the MFR value ranges from about 0.5 g/10 minutes to about 50 g/10 minutes to provide desired levels of process ability. Because high levels of filler particles blended in polymer tend to cause a decrease in MFR, the MFR value of suitable melt-extrudable polymers for the filled layers of the film may range from about 1 g/10 minutes to about 1000 g/10 minutes. In another embodiment, the MFR value of suitable melt-extrudable polymers ranges from about 4 g/10 minutes to about 500 g/10 minutes. In yet another embodiment the MFR value ranges from about 5 g/10 minutes to about 50 g/10 minutes to provide desired levels of processability.

Still more particularly, suitable melt-extrudable thermoplastic polymers for use in this invention are stretchable in solid state to allow a stretch processing of the multi-microlayered film. Stretching in solid state means stretching at a temperature below the melting point of the thermoplastic polymer. Stretching of the film reduces film thickness and may create porosity, thereby increasing the water vapor transport rate of the film and, hence, breathability. In some embodiments, films may be stretched from about 100 to about 800%, desirably from about 200 to about 700%, and more desirably from about 300 to about 600%.

The engineering tensile fracture stress (force at peak load divided by the cross-sectional area of the original specimen), tested in the machine direction orientation according to ASTM-D882-02, is useful to determine the strength of the film. In some embodiments the tensile fracture stress may range from about 600 to about 800 psi. In other embodiments the tensile fracture stress may range from about 900 to about 1800 psi. In another embodiment the tensile fracture stress may range from about 900 to about 2100 psi.

The microlayers of the film of this invention are desirably composed of a thermoplastic, melt extrudable polymer. There exists a wide variety of polymers suitable for use with the present invention. The microlayers can be made from any thermoplastic polymer suitable for film formation and desirably comprise thermoplastic polymers which can be readily stretched to reduce the film gauge or thickness. In some embodiments, the thermoplastic, melt extrudable polymer is inherently nonbreathable. By “nonbreathable” it is meant that the unfilled polymer inherently has a breathability (MOCON) less than 1000 gm/m²/day. Nonetheless, the breathability of films having alternating microlayers of filled and unfilled polymer increases as the number of microlayers increases. Film forming polymers suitable for use with the present invention, alone or in combination with other polymers, include, by way of example only, polyolefins such as, for example, polypropylene, polypropylene and polybutylene, ethylene vinyl acetate (EVA), ethylene ethyl acrylate (EEA), ethylene acrylic acid (EAA), ethylene methyl acrylate (EMA), ethylene normal butyl acrylate (EnBA), polyester, polyethylene terephthalate (PET), nylon, ethylene vinyl alcohol (EVOH), polystyrene (PS), polyurethane (PU), polybutylene (PB), polyether esters, polyether amides, and polybutylene terephthalate (PBT).

As noted above, suitable polymers for forming the microlayers, include, but are not limited to, polyolefins. A wide variety of polyolefin polymers exist and the particular composition of the polyolefin polymer and/or method of making the same is not believed critical to the present invention and thus both conventional and non-conventional polyolefins capable of forming films are believed suitable for use in the present invention. As used herein, “conventional” polyolefins refers to those made by traditional catalysts such as, for example, Ziegler-Natta catalysts. Suitable polyethylene and polypropylene polymers are widely available and, as one example, linear low density polyethylene is available from The Dow Chemical Company of Midland, Mich. under the trade name AFFINITY and conventional polypropylene is available from ExxonMobil Chemical Company of Houston, Tex. In addition, elastic and inelastic polyolefins made by “metallocene”, “constrained geometry” or “single-site” catalysts are also suitable for use in the present invention. Examples of such catalysts and polymers are described in U.S. Pat. No. 5,472,775 to Obijeski et al.; U.S. Pat. No. 5,451,450 to Erderly et al.; U.S. Pat. No. 5,278,272 to Lai et al.; U.S. Pat. No. 5,272,236 to Lai et al.; U.S. Pat. No. 5,204,429 to Kaminsky et al.; U.S. Pat. No. 5,539,124 to Etherton et al.; and U.S. Pat. No. 5,554,775 to Krishnamurti et al.; the entire contents of which are incorporated herein by reference. The aforesaid patents to Obijeski and Lai teach exemplary polyolefin elastomers and, in addition, exemplary low density polyethylene elastomers are commercially available from The Dow Chemical Company under the trade name AFFINITY, from ExxonMobil Chemical Company, under the trade name EXACT, and from Dupont Dow Elastomers, L.L.C. under the trade name ENGAGE. Moreover, exemplary propylene-ethylene copolymer plastomers and elastomers are commercially available from The Dow Chemical Company under the trade name VERSIFY and ExxonMobil Chemical Company under the trade name VISTAMAXX. Particularly suitable polymers useful in the unfilled layers include DOWLEX polyethylene resins (available from The Dow Chemical Company) and VISTAMAXX polypropylene based copolymers (available from ExxonMobil Chemical Company). Particularly suitable polymers useful for blending with the filler particles include DOWLEX 2517 LLDPE (available from the Dow Chemical Company) and polypropylene homopolymer 3155 (available from ExxonMobil Chemical Company).

Other additives may also be incorporated into the microlayers, such as melt stabilizers, crosslinking catalysts, pro-rad additives, processing stabilizers, heat stabilizers, light stabilizers, antioxidants, heat aging stabilizers, whitening agents, antiblocking agents, bonding agents, tackifiers, viscosity modifiers, etc. Examples of suitable tackifier resins may include, for instance, hydrogenated hydrocarbon resins. REGALREZ™ hydrocarbon resins are examples of such hydrogenated hydrocarbon resins, and are available from Eastman Chemical. Other tackifiers are available from ExxonMobil under the ESCOREZ™ designation. Viscosity modifiers may also be employed, such as polyethylene wax (e.g., EPOLENE™ C-10 from Eastman Chemical). Phosphite stabilizers (e.g., IRGAFOS available from Ciba Specialty Chemicals of Terrytown, N.Y. and DOVERPHOS available from Dover Chemical Corp. of Dover, Ohio) are exemplary melt stabilizers. In addition, hindered amine stabilizers (e.g., CHIMASSORB available from Ciba Specialty Chemicals) are exemplary heat and light stabilizers. Further, hindered phenols are commonly used as an antioxidant in the production of microlayer films. Some suitable hindered phenols include those available from Ciba Specialty Chemicals of under the trade name “Irganox®”, such as Irganox® 1076, 1010, or E 201. Moreover, bonding agents may also be added to the film to facilitate bonding of the film to additional materials (e.g., nonwoven web). Typically, such additives (e.g., tackifier, antioxidant, stabilizer, etc.) are each present in an amount from about 0.001 wt. % to about 25 wt. %, in some embodiments, from about 0.005 wt. % to about 20 wt. %, and in some embodiments, from 0.01 wt. % to about 15 wt. % of the film.

The films of the present invention have an increased breathability when compared to films having the same overall composition but not formed into alternating filled and unfilled microlayers. The breathability of the multi-microlayer film is expressed as water vapor transmission rate (WVTR) determined by Mocon testing. In one embodiment, the multi-microlayer film may have breathability in a range of about 500 g/day/m² to about 25,000 g/day/m². In another embodiment, the multi-microlayer film may have breathability in a range of about 1000 g/day/m² to about 20,000 g/day/m² using the Mocon WVTR test procedure. A suitable technique for determining the WVTR value of a film of the invention is the test procedure standardized by INDA (Association of the Nonwoven Fabrick Industry), number IST-70.4-99 which is incorporated by reference herein. The testing device which may be used for WVTR measurement is known as the Permatran-W Model 100K manufactured by Mocon/Modern Controls, Inc., business having an office in Minneapolis, Minn.

As noted above, breathability of the microlayer films is achieved by incorporating a particulate filler into alternating layers of the microlayer film. Particulate filler material creates discontinuity in the microlayers to provide pathways for water vapor to move through the film. Particulate filler material may also enhance the ability of the microlayer film to absorb or immobilize fluid, enhance biodegradation of the film, provide porosity-initiating debonding sites to enhance the formation of pores when the microlayer film is stretched, improve processability of the microlayer film and reduce production cost of the microlayer film. In addition, lubricating and release agents may facilitate the formation of microvoids and the development of a porous structure in the film during stretching of the film and may reduce adhesion and friction at filler-resin interface. Surface active materials such as surfactants coated on the filler material may reduce the surface energy of the film, increase hydrophilicity of the film, reduce film stickiness, provide lubrication, or reduce the coefficient of friction of the film.

Suitable filler materials may be organic or inorganic, and are desirably in a form of individual, discrete particles. Suitable inorganic filler materials include metal oxides, metal hydroxides, metal carbonates, metal sulfates, various kinds of clay, silica, alumina, powdered metals, glass microspheres, or vugular void-containing particles. Particularly suitable filler materials include calcium carbonate, barium sulfate, sodium carbonate, magnesium carbonate, magnesium sulfate, barium carbonate, kaolin, carbon, carbon black, graphite, graphene, and other predominantly carbonaceous solids, calcium oxide, magnesium oxide, aluminum hydroxide, and titanium dioxide. Still other inorganic fillers may include those with particles having higher aspect ratios such as talc, mica and wollastonite. Suitable organic filler materials include, for example, latex particles, particles of thermoplastic elastomers, pulp powders, wood powders, cellulose derivatives, chitin, chitosan powder, powders of highly crystalline, high melting polymers, beads of highly crosslinked polymers, organosilicone powders, and powders or particles of super absorbent polymers, such as polyacrylic acid and the like, as well as combinations and derivatives thereof. Particles of super absorbent polymers or other superabsorbent materials may provide for fluid immobilization within the microlayer film. These filler materials may improve toughness, softness, opacity, vapor transport rate (breathability), biodegradability, fluid immobilization and absorption, skin wellness, and other beneficial attributes of the microlayer film.

The particulate filler material is suitably present in alternate microlayers of the microlayer film in an amount from about 10% to about 90% by weight of the film. In one embodiment, the average particle size of the filler material does not exceed about 200 microns. In another embodiment, the average particle size of the filler does not exceed about 50 microns. In still another embodiment, the average particle size of the filler does not exceed about 5 microns. In yet another embodiment, the average particle size of the filler does not exceed about 3 microns.

Suitable commercially available filler materials include the following:
1. SUPERMITE®, an ultrafine ground CaCO₃, which is available from Imerys of Atlanta, Ga. This material has a top cut particle size of about 8 microns and a mean particle size of about 1 micron and may be coated with a surfactant, such as Dow Corning 193 surfactant, before mixing with the polymer.
2. SUPERCOAT®, a coated ultrafine ground CaCO₃, which is available from Imerys of Atlanta, Ga. This material has a top cut particle size of about 8 microns and a mean particle size of about 1 micron.
3. OMYACARB® UF, high purity, ultrafine, wet ground CaCO₃, which is available from OMYA, Inc., of Proctor, Vt. This material has a top cut particle size of about 4 microns and an average particle size of about 0.7 microns and provides good processability. This filler may also be coated with a surfactant such as Dow Corning 193 surfactant before mixing with the polymer.
4. OMYACARB® UFT CaCO₃, an ultrafine pigment surface coated with stearic acid, available from OMYA, Inc. This material has a top cut particle size of about 4 microns and a mean particle size of about 0.7 microns and provides good processability.

The filler may also include superabsorbent particles such as finely ground polyacrylic acid or other superabsorbent particles. The superabsorbent filler in the film with microlayers may provide absorption of fluids and may expand into the pores provided by the filler and improve fluid wetting, fluid retention, fluid absorption and distribution properties.

Surfactants may increase the hydrophilicity and wettability of the film, and enhance the water vapor permeability of the film, and may improve filler dispersion in the polymer. For example, surfactant or the surface active material may be blended with the polymers forming the microlayers or otherwise incorporated onto the particulate filler material before the filler material is mixed with the polymer. Suitable surfactants or surface active materials may have a hydrophile-lipophile balance (HLB) number from about 6 to about 18. Desirably, the HLB number of the surface active material or a surfactant ranges from about 8 to about 16, and more desirably ranges from about 12 to about 15 to enable wettability by aqueous fluids. When the HLB number is too low, the wettability may be insufficient and when the HLB number is too high, the surface active material may have insufficient adhesion to the polymer matrix of elastomeric layer and/or non-elastomer layer, and may be too easily washed away during use. The surfactant modification or treatment of the microlayer film or the components of the microlayer film may provide a water contact angle of less than 90 degrees. Preferably surfactant modification may provide a water contact angle of less than 70 degrees. For example, incorporation of the Dow Corning 193 surfactant into the film components may provide a water contact angle of about 40 degrees. A number of commercially available surfactants may be found in McMcutcheon's Vol. 2; Functional Materials, 1995.

Suitable surfactants and surface-active materials for blending with the polymeric components of the microlayer film or treating the particulate filler material include silicone glycol copolymers, ethylene glycol oligomers, acrylic acid, hydrogen-bonded complexes, carboxylated alcohol, ethoxylates, various ethoxylated alcohols, ethoxylated alkyl phenols, ethoxylated fatty esters, stearic acid, behenic acid, and the like, as well as combinations thereof. Suitable commercially available surfactants include the following:
1. Surfactants composed of ethoxylated alkyl phenols, such as Igepal RC-620, RC-630, CA-620, 630, 720, CO-530, 610, 630, 660, 710, and 730, which are available from Rhone-Poulenc, Inc. of Cranbury, N.J.
2. Surfactants composed of silicone glycol copolymers, such as Dow Corning D190, D193, FF400, and D1315, available from Dow Corning of Midland, Mich.
3. Surfactants composed of ethoxylated mono and diglycerides, such as Mazol® 80 MGK, Masil® SF 19, and Mazol® 165 C, available from PPG Industries of Gurnee, Ill.
4. Surfactants composed of ethoxylated alcohols, such as Genapol 26-L-98N, Genapol 26-L60N, and Genapol 26-L-5 which are available from Hoechst Celanese Corporation of Charlotte, N.C.
5. Surfactants composed of carboxylated alcohol ethoxylates, such as Marlowet 4700 and Marlowet 4703, which are available from Huls America, Inc. of Piscataway, N.J.
6. Ethoxylated fatty esters, such as Pationic 138C, Pationic 122A, Pationic SSL, which are available from R.I.T.A. Corporation of Woodstock, Ill.

The surface activate material is suitably present in the respective microlayer in an amount from about 0.5 to about 20% by weight of the microlayer. Even more particularly, the surface active material is present in the respective microlayer in an amount from about 1 to about 15% by weight of the microlayer, and more particularly in an amount from about 2 to about 10% by weight of the microlayer. The surface activate material may be suitably present on the particulate in an amount of from about 1 to about 12% by weight of the filler material. The surfactant or surface active material may be blended with suitable polymers to form a concentrate. The concentrate may be mixed or blended with polymers forming the alternate microlayers.

The multi-microlayer film may further include one or two additional skin layer(s) on the outer surfaces of the multi-microlayer film. The skin layer(s) may enhance breathability, impart electrostatic dissipation, stabilize the film during extrusion, or provide other benefits to the overall structure. The skin layer(s) may generally be formed from any film-forming polymer. If desired, the skin layer(s) may contain a softer, lower melting polymer or polymer blend that renders the skin layer(s) more suitable as heat seal bonding layers for thermally bonding the film to a nonwoven web. In most embodiments, the skin layer(s) are formed from a film-forming, thermoplastic, melt extrudable polymers such as described above.

In such embodiments, the skin layer(s) may contain filler particles as described above, or the layer(s) may be free of a filler. When a skin layer is free of filler, one objective is to alleviate the build-up of filler at the extrusion die lip that may otherwise result from extrusion of a filled film. When a skin layer contains filler, one objective is to provide a suitable bonding layer without adversely affecting the overall breathability of the film.

In one particular embodiment, the skin layer(s) may employ a lubricant that may migrate to the surface of the film during extrusion to improve its processability.

The lubricants are typically liquid at room temperature and substantially immiscible with water. Non-limiting examples of such lubricants include oils (e.g., petroleum based oils, vegetable based oils, mineral oils, natural or synthetic oils, silicone oils, lanolin and lanolin derivatives, kaolin and kaolin derivatives, and so forth); esters (e.g., cetyl palmitate, stearyl palmitate, cetyl stearate, isopropyl laurate, isopropyl myristate, isopropyl palmitate, and so forth); glycerol esters; ethers (e.g., eucalyptol, cetearyl glucoside, dimethyl isosorbicide polyglyceryl-3 cetyl ether, polyglyceryl-3 decyltetradecanol, propylene glycol myristyl ether, and so forth); alkoxylated carboxylic acids; alkoxylated alcohols; fatty alcohols (e.g., octyldodecanol, lauryl, myristyl, cetyl, stearyl and behenyl alcohol, and so forth); etc. In one particular embodiment, the lubricant is alpha tocephrol (vitamin E) (e.g., Irganox® E 201). Other suitable lubricants are described in U.S. Patent Application Publication No. 2005/0258562 to Wilson, et al., which is incorporated herein in its entirety by reference thereto for all purposes. Organopolysiloxane processing aids may also be employed that coat the metal surface of melt-processing equipment and enhance ease of processing. Examples of suitable polyorganosiloxanes are described in U.S. Pat. Nos. 4,535,113; 4,857,593; 4,925,890; 4,931,492; and 5,003,023, which are incorporated herein in their entirety by reference thereto for all purposes. A particular suitable organopolysiloxane is SILQUEST® PA-1, which is commercially available from GE Silicones.

The thickness of the skin layer(s) is generally selected so as not to substantially impair the moisture transmission through the multi-microlayer film. In this manner, the multi-microlayer film may determine the breathability of the entire film, and the skin layers will not substantially reduce or block the breathability of the film. To this end, each skin layer may separately comprise from about 0.5% to about 15% of the total thickness of the film, and in some embodiments from about 1% to about 10% of the total thickness of the film. For instance, each skin layer may have a thickness of from about 0.1 to about 10 microns, in some embodiments from about 0.5 to about 5 microns, and in some embodiments, from about 1 to about 2.5 microns.

The breathable microlayer films may be post-processed to stabilize the film structure. The post processing may be done by a thermal point or pattern bonding, by embossing, by sealing edges of the film using heat or ultrasonic energy, or by other operations known in the art. One or more nonwoven webs may be laminated to the film with microlayers to improve strength of the film, its tactile properties, appearance, or other beneficial properties of the film. The nonwoven webs may be spunbond webs, meltblown webs, bonded carded webs, airlaid or wet laid webs, or other nonwoven webs known in the art.

The films may also be perforated before stretching or after stretching. The perforations may provide z-directional channels for fluid access, absorption and transport, and may improve vapor transport rate. Perforation may be accomplished by punching holes using pins of varying diameter, density, and configuration, which may be arranged into a pattern desired for a specific application of the film. The pins to punch holes and perforate the film may be optionally heated. Other methods known in the art may be also used to perforate the film; for example, high speed and intensity water jets, high intensity laser beams, or vacuum aperture techniques may be used to generate a desired pattern of holes in the film of the invention. The holes or perforation channels may penetrate through the entire thickness of the film or may partially perforate the film to a specified channel depth.

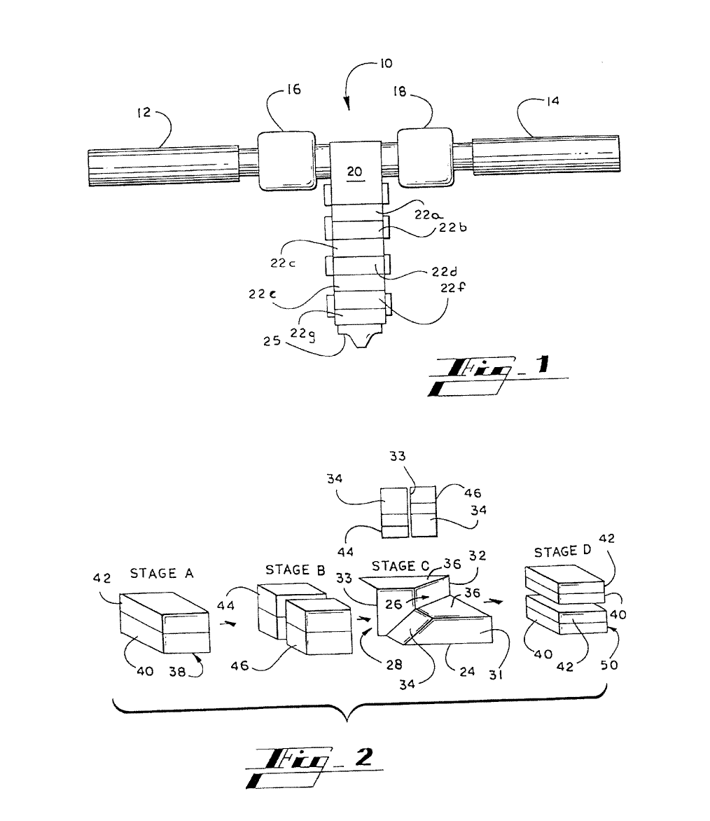

A suitable method for making the microlayer film of this invention is a microlayer coextrusion process wherein two or more polymers are coextruded to form a laminate with two or more layers, which laminate is then manipulated to multiply the number of layers in the film. FIG. 1 illustrates a coextrusion device 10 for forming microlayer films. This device includes a pair of opposed single-screw extruders 12 and 14 connected through respective metering pumps 16 and 18 to a coextrusion block 20. A plurality of multiplying elements 22a-g extends in series from the coextrusion block perpendicularly to the single-screw extruders 12 and 14. Each of the multiplying elements includes a die element 24 disposed in the melt flow passageway of the coextrusion device. The last multiplying element 22g is attached to a discharge nozzle 25, for example, a film die, through which the final product extrudes. While single-screw extruders are shown, the present invention may also use twin-screw extruders to form the films of the present invention.

A schematic diagram of the coextrusion process carried out by the coextrusion device 10 is illustrated in FIG. 2. FIG. 2 also illustrates the structure of the die element 24 disposed in each of the multiplying elements 22a-g. Each die element 24 divides the melt flow passage into two passages 26 and 28 with adjacent blocks 31 and 32 separated by a dividing wall 33. Each of the blocks 31 and 32 includes a ramp 34 and an expansion platform 36. The ramps 34 of the respective die element blocks 31 and 32 slope from opposite sides of the melt flow passage toward the center of the melt flow passage. The expansion platforms 36 extend from the ramps 34 on top of one another.

To make a microlayer film using the coextrusion device 10 illustrated in FIG. 1, a thermoplastic polymer, such as, for example, polypropylene or polyethylene, is extruded through the first single screw extruder 12 into the coextrusion block 20. Likewise, a blend of a thermoplastic polymer and a particulate filler material, is extruded through the second single screw extruder 14 into the same coextrusion block 20. In the coextrusion block 20, a melt laminate structure 38 such as that illustrated at stage A in FIG. 2 is formed with the thermoplastic polymer forming a layer on top of a layer of thermoplastic polymer and filler. The coextrusion block 20 can be configured to provide an “asymmetrical” side-by-side configuration of the polymers from the two extruders 12, 14 (i.e., A/B configuration) or a “symmetrical” skin/core/skin configuration (i.e., A/B/A). Other starting structures may be coextruded from the feedblock as will be appreciated by one skilled in the art. For example, in another embodiment, a third tie layer “C” (not shown) may be extruded by a third extruder (not shown) between “A” and “B” layers via an extrusion block configured to provide an A/C/B arrangement, or, alternatively, an A/C/B/C arrangement. Coextrusion blocks configured to provide an “asymmetric” flow such as A/B will likewise produce an “asymmetric” micro-multilayer film. That is, one outer (terminating) surface will always be predominantly composed of “A”, and the other terminating surface will always be predominantly composed of “B”. Similarly, extrusion blocks configured to provide a “symmetric” A/B/A flow element will produce a “symmetric” micro-multilayer film. That is, both terminating layers will be composed of “A”.

Surprisingly, in the present invention, properties such as moisture vapor transport were found to be influenced by the terminating layer composition of the multi-microlayer film. Specifically, moisture vapor transport was found to be measurably greater in films having one or two terminating layers containing particulate filler.

However, good moisture vapor transport even resulted from multi-microlayer films in which both terminating layers were inherently impermeable to water (containing no filler). This phenomenon is believed to result from the thickness of an individual microlayer being smaller than the mean size of the filler particles.

The melt laminate is then extruded through the series of multiplying elements 22a-g to form a multi-layer microlaminate with the layers alternating between the thermoplastic polymer and the blend of thermoplastic polymer and filler. As the two-layer melt laminate is extruded through the first multiplying element 22a, the dividing wall 33 of the die element 24 splits the melt laminate 38 into two halves 44 and 46 each having a layer of thermoplastic polymer 40 and a layer of the blend of the thermoplastic polymer and the filler 42. This is illustrated at stage B in FIG. 2. As the melt laminate 38 is split, each of the halves 44 and 46 are forced along the respective ramps 34 and out of the die element 24 along the respective expansion platforms 36. This reconfiguration of the melt laminate is illustrated at stage C in FIG. 2. When the melt laminate 38 exits from the die element 24, the expansion platform 36 positions the split halves 44 and 46 on top of one another to form a four-layer melt laminate 50 having, in parallel stacking arrangement, a thermoplastic polymer layer, a layer of the blend of thermoplastic polymer and filler, a thermoplastic polymer layer and a layer of the blend of thermoplastic polymer and filler in laminate form. This process is repeated as the melt laminate proceeds through each of the multiplying elements 22b-g. When the melt laminate is discharged through the discharge nozzle 25, the melt laminate forms a film having from about 4 to about 1000 microlayers, depending on the number of multiplying elements.

The foregoing microlayer coextrusion device and process is described in more detail in an article Mueller et al., entitled Novel Structures By Microlayer Extrusion-Talc-Filled PP, PC/SAN, and HDPE-LLDPE, Polymer Engineering and Science, Vol. 37, No. 2, 1997. Similar processes are described in U.S. Pat. No. 3,576,707 and U.S. Pat. No. 3,051,453, the disclosures of which are expressly incorporated herein by reference. Other processes known in the art to form multi-microlayer film may also be employed, e.g., coextrusion processes described in W. J. Schrenk and T. Ashley, Jr., “Coextruded Multilayer Polymer Films and Sheets, Polymer Blends”, Vol. 2, Academic Press, New York (1978).

The relative thickness of the microlayers of the film made by the foregoing process may be controlled by varying the feed ratio of the polymers into the extruders, thus controlling the constituent volume fraction. In addition, one or more extruders may be added to the coextrusion device to increase the number of different polymers in the microlayer film. For example, a third extruder may be added to add a tie layer to the film.

The microlayer film may be made breathable by subjecting the film to a selected plurality of stretching operations, such as uniaxial stretching operation or biaxial stretching operation. Stretching operations may provide microporous microlayer film with a distinctive porous microlayered morphology, may enhance water vapor transport through the film, and may improve water access, and enhance degradability of the film. In a first embodiment, the film may be stretched from about 100 to about 1000 percent of its original length. In another embodiment, the film may be stretched from about 100 to about 800 percent of its original length, an in a further embodiment the film may be stretched from about 200 to about 600 percent of its original length.

The parameters during stretching operations include stretching draw ratio, stretching strain rate, and stretching temperature. Stretching temperatures may be in the range of from about 15° C. to about 100° C. In another embodiment, stretching temperatures may be in the range of from about 25° C. to about 85° C. During stretching operation, the multi-microlayer film sample may optionally be heated to provide a desired effectiveness of the stretching.

In one particular aspect of the invention, the draw or stretching system may be constructed and arranged to generate a draw ratio which is not less than about 2 in the machine and/or transverse directions. The draw ratio is the ratio determined by dividing the final stretched length of the microlayer film by the original unstretched length of the microlayer film along the direction of stretching. The draw ratio in the machine direction (MD) should not be less than about 2. In another embodiment, the draw ratio is not less than about 2.5 and in yet another embodiment is not less than about 3.0. In another aspect, the stretching draw ratio in the MD is not more than about 11. In another embodiment, the draw ratio is not more than about 7.

When stretching is arranged in the transverse direction, the stretching draw ratio in the transverse direction (TD) is generally not less than about 2. In another embodiment, the draw ratio in the TD is not less than about 2.5 and in yet another embodiment is not less than about 3.0. In another aspect, the stretching draw ratio in the TD is not more than about 11. In another embodiment, the draw ratio is not more than about 7. In yet another embodiment the draw ratio is not more than about 5.

The biaxial stretching, if used, may be accomplished simultaneously or sequentially. With the sequential, biaxial stretching, the initial stretching may be performed in either the MD or the TD.

The microlayer film of the invention may be pretreated to prepare the film for the subsequent stretching operations. The pretreatment may be done by annealing the film at elevated temperatures, by spraying the film with a surface-active fluid (such as a liquid or vapor from the surface-active material employed to surface-modify the filler material or modify the components of the film), by modifying the physical state of the microlayer film with ultraviolet radiation treatment, an ultrasonic treatment, e-beam treatment, or a high-energy radiation treatment. Pretreatment may also include perforation of the film, generation of z-directional channels of varying size and shapes, penetrating through the film thickness. In addition, the pretreatment of the microlayer film may incorporate a selected combination of two or more of the techniques. A suitable stretching technique is disclosed in U.S. Pat. No. 5,800,758, the disclosure of which is hereby incorporated in its entirety.

The film with microlayers may be post-treated. The post-treatment may be done by point bonding the film, by calendaring the film, by sealing edges of the film, and by perforation of the film, including generation of channels penetrating through the film thickness.

The microlayer film of this invention may be laminated to one or more nonwoven webs. The nonwoven webs may be spunbond webs, meltblown webs, bonded carded webs, airlaid or wet laid webs, or other nonwoven webs known in the art.

Accordingly, the microlayer film of this invention is suitable for absorbent personal care items including diapers, adult incontinence products, feminine care absorbent products, training pants, and health care products such as wound dressings. The microlayer film of this invention may also be used to make surgical drapes and surgical gowns and other disposable garments.

Lamination may be accomplished using thermal or adhesive bonding as known in the art. Thermal bonding may be accomplished by, for example, point bonding.

The adhesive may be applied by, for example, melt spraying, printing or meltblowing. Various types of adhesives are available including those produced from amorphous polyalphaolefins and ethylene vinyl acetate-based hot melts.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLES

As mentioned above, the engineering tensile peak force and stress (force at failure peak load divided by the cross-sectional are of the original specimen) is tested in the machine direction orientation according to ASTM-D882-02. The “single sheet caliper” is measured as one sheet using an EMVECO 200-A Microgage automated micrometer (EMVECO, Inc., Oregon). The micrometer has an anvil diameter of 2.22 inches (56.4 millimeters) and an anvil pressure of 132 grams per square inch (per 6.45 square centimeters) (2.0 kPa). Basis weight is the mass per unit area of film and is generally expressed in units of grams per square meter.

The WVTR (water vapor transmission rate) value of was determined using the test procedure standardized by INDA (Association of the Nonwoven Fabrics Industry), number IST-70.4-99, entitled “STANDARD TEST METHOD FOR WATER VAPOR TRANSMISSION RATE THROUGH NONWOVEN AND PLASTIC FILM USING A GUARD FILM AND VAPOR PRESSURE SENSOR”, which is incorporated herein in its entirety by reference thereto for all purposes. The INDA test procedure is summarized as follows. A dry chamber is separated from a wet chamber of known temperature and humidity by a permanent guard film and the sample material to be tested. The purpose of the guard film is to define a definite air gap and to quiet or still the air in the air gap while the air gap is characterized. The dry chamber, guard film, and the wet chamber make up a diffusion cell in which the test film is sealed. The sample holder is known as the Permatran-W Model 100K manufactured by Mocon/Modem Controls, Inc., Minneapolis, Minn. A first test is made of the WVTR of the guard film and the air gap between an evaporator assembly that generates 100% relative humidity. Water vapor diffuses through the air gap and the guard film and then mixes with a dry gas flow that is proportional to water vapor concentration. The electrical signal is routed to a computer for processing. The computer calculates the transmission rate of the air gap and the guard film and stores the value for further use.

The transmission rate of the guard film and air gap is stored in the computer as CalC. The sample material is then sealed in the test cell. Again, water vapor diffuses through the air gap to the guard film and the test material and then mixes with a dry gas flow that sweeps the test material. Also, again, this mixture is carried to the vapor sensor. The computer then calculates the transmission rate of the combination of the air gap, the guard film, and the test material. This information is then used to calculate the transmission rate at which moisture is transmitted through the test material according to the equation:

TR-1_{test material}=TR-1_{test material,guardfilm,airgap}−TR-1_{guardfilm,airgap}

The water vapor transmission rate (“WVTR”) is then calculated as follows:

WVTR=Fpₛₐₜ(T)RH/APₛₐₜ(T)(1−RH)

wherein,
F=the flow of water vapor in cm³ per minute;
pₛₐₜ(T)=the density of water in saturated air at temperature T;
RH=the relative humidity at specified locations in the cell;
A=the cross sectional area of the cell; and
Pₛₐₜ(T)=the saturation vapor pressure of water vapor at temperature T.

Electron micrographs may be generated by conventional techniques that are well known in the imaging art. In addition, samples may be prepared by employing well known, conventional preparation techniques. For example, the imaging of the cross-section surfaces may be performed with a JEOL 6400 SEM.

The inventors have found that alternating microlayers of polymer with and without CaCO₃ filler particles, via multi-layer die assemblies (i.e., referred to as “splitters”), results in a film having greater breathability at equivalent film composition (i.e., equivalent resin and wt % CaCO₃). The resulting layered films have alternating layers with and without CaCO₃ filler, as compared to the control films in which all layers contain CaCO₃ filler. The CaCO₃ rich regions have a greater number of pores, as well as larger pores. The films containing alternating layers with and with CaCO₃ filler had higher levels of breathability and increased levels of strain to break.

Microporous films were extruded via a micro-layering film line and hand stretched at room temperature. Films produced by layering in the filled polymer blend of CaCO₃ filler and thermoplastic polymer (75 wt % CaCO₃ (1-3 microns in size) and 25 wt % Dowlex 2517 LLDPE, same filled polymer blend used in all codes) with layers of the thermoplastic polymer without filler (Dowlex 2047G LLDPE) using three splitters (16 layers) had a median WVTR value of 17,000 gm/m²-day. The ratio of the layers was such that the overall wt. % of CaCO₃ was 56 wt %. Control films produced from a blend of the filled polymer blend and thermoplastic polymer (overall CaCO₃ wt %=56%) had a median WVTR value of 16.00 gm/m²-day. Films produced by layering in the same ratio of filled polymer blend and thermoplastic polymer with layers of the thermoplastic polymer without filler using six splitters (128 layers) had a median WVTR value of 29,000 gm/m²-day. Control micro-layer films produced by using filled polymer blend for both initial layers (i.e., not alternating layers with and without filler) with three and six splitters had median WVTR of <15,000 gm/m²-day. Thus, alternating the layers with and without CaCO₃ filler via splitters was found to improve breathability and, in the case of six splitters (128 layers), improve breathability by >50%.

Microporous films were extruded via a micro-layering film line and stretched with a machine direction orienter (MDO). Control films were produced from the filled polymer blend and thermoplastic polymer as above. Using the MDO, the stretch ratio resulting in breakage of the film was determined, at which point the stretch ratio was reduced such that film could be wound without breaking. The Control films stretched in this fashion had median WVTR values of 19,000 gm/m²-day. Two sets of films produced by layering in the filled polymer blend with layers of the thermoplastic polymer without filler (as described above) using six splitters were stretched using different stretching conditions (i.e., different stretch temperatures). In both cases, films were stretched to the point of breaking, at which point the stretch ratio was reduced such that film could be wound without breaking. At one stretch temperature the layered microporous film had a median WVTR of 30,000 gm/m²-day. At a second stretch temperature the layered microporous film had a median WVTR of 40,000 gm/m²-day. Thus, alternating the layers with and without CaCO₃ filler via splitters was found to improve breathability by >50%.

The obtained experimental results demonstrate that microlayer films of thermoplastic polymer having alternating layers with and without filler material demonstrate improved breathability over similar films not alternating layers with and with filler.

Further samples were produced as set forth in the table below:

| | | Mean CD | Mean MD |
|---|---|---|---|
| | Mean WVTR | Peak Force | Peak Force |
| | (g/m2*day) | (lbs/in) | (lbs/in) |
| Control(all components | 10,000 | 2.9 | 3.0 |
| blended), 75/25 wt % | | | |
| filled polymer blend/ | | | |
| unfilled polymer, 70 gsm | | | |
| Layered, 75/25 wt % | 35,000 | 2.7 | 3.4 |
| filled polymer blend/ | | | |
| unfilled polymer, 70 gsm | | | |
| Layered, 70/30 wt % | 15,000 | 2.7 | 3.0 |
| filled polymer blend/ | | | |
| unfilled polymer, 55 gsm | | | |
| Layered, 66/34 wt % | 8,000 | 2.8 | 3.9 |
| filled polymer blend/ | | | |
| unfilled polymer, 55 gsm | | | |

From the data, it can be seen that at equivalent as-cast basis weight (70 gsm), composition (75/25 wt % filled polymer blend/unfilled polymer), and level of stretch, “layering” provides an increase in breathability compared to the unlayered control, higher MD strength, and lower CD strength.

From the data in the table, it can be seen that reducing basis weight by 20% to 55 gsm and changing composition to 70/30 wt % filled polymer blend/unfilled polymer, the “layered” film has higher breathability compared to the unlayered control, equivalent MD strength, and lower CD strength.

From the data in the table, it can be seen that at 55 gsm and changing composition to 66/34 wt % filled polymer blend/unfilled polymer, the “layered” film has similar breathability compared to the unlayered control, higher MD strength, and similar CD strength.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A multi-microlayer film comprising a plurality of alternating coextruded first and second microlayers, wherein the first microlayers comprise an unfilled first polymer composition, and further wherein the second microlayers comprise a second polymer composition and filler particles.

2. The multi-microlayer film of claim 1 wherein the unfilled first polymer composition has an inherent WVTR by itself less than about 1000 gm/m²/day, optionally less than about 300 gm/m²/day.

3. The multi-microlayer film of claim 1, wherein the filler particles are selected from the group consisting of metal oxides, metal hydroxides, metal carbonates, carbon black, graphite, graphene, and other predominantly carbonaceous solids, metal sulfates, calcium carbonate, clay, alumina, titanium dioxide, rubber powder, rubber emulsions, pulp powder, wood powder, chitosan powder, acrylic acid powder, or mixtures thereof.

4. The multi-microlayer film of claim 1, wherein the multi-microlayer film has a thickness less than about 254 microns.

5. The multi-microlayer film of claim 1, wherein each microlayer has a thickness of from about 0.001 microns to about 50 microns.

6. The multi-microlayer film of claim 1, wherein the multi-microlayer film comprises from about 8 to about 4000 microlayers, optionally from about 16 to about 2048 microlayers.

7. The multi-microlayer film of claim 1 further comprising outer skin layers surrounding the microlayers.

8. The multi-microlayer film of claim 1, wherein the multi-microlayer film is breathable, optionally wherein the multi-microlayer film has a WVTR greater than about 1000 gm/m²/day, optionally wherein the multi-microlayer film has a WVTR greater than about 21,000 gm/m²/day, and optionally wherein the multi-microlayer film has a WVTR between about 1000 and about 40,000 gm/m²/day.

9. The multi-microlayer film of claim 1, wherein the multi-microlayer film has been stretched from about 100 to about 1000 percent of the film's original as-formed length.

10. The multi-microlayer film of claim 1 wherein the second micro-layers comprise between about 25 wt % and about 95 wt % filler particles by weight of the second micro-layers, optionally wherein the second micro-layers optionally comprise between about 60 wt % and about 75 wt % filler particles by weight of the second micro-layers.

11. The multi-microlayer film of claim 1 comprising between about 10 wt % and about 90 wt % filler particles by weight of the multi-microlayer film, optionally comprising between about 30 wt % and about 70 wt % filler particles by weight of the multi-microlayer film.

12. The multi-microlayer film of claim 1 wherein a second microlayer comprises neither outermost layer of the multi-microlayer film, optionally one outermost layer of the multi-microlayer film, and optionally both outermost layers of the multi-microlayer film.

13. The multi-microlayer film of claim 1, wherein the multi-microlayer film has a WVTR greater than 1.25× that of an otherwise equivalent non-layered film having the same weight percentage of filler particles and polymer composition.

14. The multi-microlayer film of claim 1, wherein the multi-microlayer film has substantially equivalent WVTR to that of an otherwise equivalent non-layered film having greater overall weight percentage of filler particles.

15. The multi-microlayer film of claim 14, wherein the multi-microlayer film has an MD peak tensile force greater than that of an otherwise equivalent non-layered film having greater overall weight percentage of filler particles.

16. A nonwoven composite comprising a nonwoven material and the multi-microlayer film of claim 1 laminated to the nonwoven material.

17. An absorbent article comprising an outer cover, a bodyside liner joined to the outer cover, and an absorbent core positioned between the outer cover and the bodyside liner, wherein the absorbent article includes the nonwoven composite of claim 10.

18. The multi-microlayer film of claim 1, wherein the first unfilled polymer composition comprises a polymer selected from the group consisting of polyolefins and polyolefin copolymers.

19. The multi-microlayer film of claim 1, wherein the second polymer composition comprises a polymer selected from the group consisting of polyolefins and polyolefin copolymers.

20. A method of making a multi-microlayer breathable film, the method comprising the steps of
providing first and second unfilled polymer compositions;
blending filler particles with the second unfilled polymer composition to form a filled polymer composition;
coextruding the first unfilled polymer composition and the filled polymer composition;
splitting the first unfilled polymer composition and the filled polymer composition into multiple alternating layers; and,
forming the multiple alternating layers into a multi-microlayer film having alternating coextruded microlayers.

21. The method of claim 20, wherein the filler particles are selected from the group consisting of metal oxides, metal hydroxides, metal carbonates, carbon black, graphite, graphene, and other predominantly carbonaceous solids, metal sulfates, calcium carbonate, clay, alumina, titanium dioxide, rubber powder, rubber emulsions, pulp powder, wood powder, chitosan powder, acrylic acid powder, or mixtures thereof.

22. The method of claim 20, wherein each microlayer has a thickness of from about 0.001 microns to about 50 microns.

23. The method of claim 18, wherein the multi-microlayer film has a thickness less than about 254 microns.

24. The method of claim 20, wherein the multi-microlayer film comprises from about 8 to about 4,000 microlayers, optionally from about 16 to about 2048 microlayers.

25. The method of claim 20, wherein the multi-microlayer film is breathable, optionally wherein the multi-microlayer film has a WVTR greater than about 1000 gm/m²/day, optionally wherein the multi-microlayer film has a WVTR greater than about 21,000 gm/m²/day, and optionally wherein the multi-microlayer film has a WVTR between about 1000 and about 40,000 gm/m²/day.

26. The method of claim 20, wherein the multi-microlayer film has a WVTR greater than 1.25× that of an otherwise equivalent non-layered film having the same weight percentage of filler particles and polymer composition.

27. The method of claim 20, further comprising stretching the multi-microlayer film from about 100 to about 800 percent of the film's original as-formed length.

28. The method of claim 20, wherein the first unfilled polymer composition comprises a polymer selected from the group consisting of polyolefins and polyolefin copolymers.

29. The method of claim 20, wherein the second unfilled polymer composition comprises a polymer selected from the group consisting of polyolefins and polyolefin copolymers.
